(19) United States
(12) Patent Application Publication
(10) Pub. No.: US 2002/0070879 A1
(43) Pub. Date: Jun. 13, 2002

(54) "On-board" vehicle safety system

(76) Inventors: Hanoch Amatzia Gazit, Kfar Saba (IL); Doron David Cohen, Givat Ela (IL)

Correspondence Address: DR. D. GRAESER LTD., C/O THE POLKINGHORNS, 9003 FLORIN WAY, UPPER MARLBORO, MD, 20772, US

(21) Appl. No.: 09/733,996

(22) Filed: Dec. 12, 2000

(51) Int. Cl. G08G 1/00

(52) U.S. Cl. 340/901; 340/903; 340/436; 340/435; 340/539; 340/10.1

(57) ABSTRACT

A mobile visual display system including one or more vehicles, and equipped with an external display panel and an internal display panel, capable of delivering changeable messages e.g., LED, liquid crystal, etc., and a programmable on-board controller CPU, which drives the display panels to provide a viewable message. The controller CPU ascertains that the vehicle is within a predefined geographic zone, which can be customized for each message and drives external display to generate a message selected for public viewing. The message is displayed on external display, pursuant to a schedule stored on a database, which includes date, time of day and display duration while the vehicle is within the zone or until the vehicle is located in another zone which is not within the message schedule.

### FIELD AND BACKGROUND OF THE INVENTION

The present invention relates to Vehicle safety systems and apparatus and, in particular, it concerns an “on-board” “anti collision” system and apparatus which can also be used to receive and display messages and a variety of different media.

Since the Advent of the Motor vehicle, a plethora of attempts have been made to improve safety for both passengers and pedestrians. Furthermore, due to the mobility of vehicles, several attempts have been made to utilize vehicles for advertising and the like.

Among the many prior art teachings, a skilled artisan can, among others, the following examples:

U.S. Pat. No. 6,085,148 teaches an apparatus for automatically disseminating information corresponding to a location includes a location identification device for providing a current location, a presentation device for presenting the information to a user, a controller operably connected to control the presentation device, and a storage device operably connected to the controller for storing the information and predefined location data linking the location to the information. In one embodiment, the controller may include a processor programmed to receive the current location from the location identification device and compare the current location with the predefined location data. The apparatus may further include a memory device containing data structures including the current location data corresponding to a current location, the predefined location data, a comparison module for reading the current location data and comparing the current location data with the predefined location data, and a presentation module for controlling the output of the information to the presentation device from the storage device.

Furthermore, Mobile displays have proven to be as an effective advertising medium and has remained intact from inception in virtually all formats, from the person wearing a sandwich board to the ice cream vendor's truck with an illustration of an ice cream cone, trucks indicating the source of their contents, taxi, bus, railroad and subway car billboards and more recent innovations, such as, buses entirely wrapped in electrostatic marking film carrying advertising graphics as well as vehicles, without cargo, carrying billboards traversing streets of metropolitan areas.

Further still, advertising is known to be time and location sensitive. Among the disadvantages heretofore encountered with vehicle mounted visual displays has been the inability to efficiently deliver the intended message to a target audience in desired geographic zones and specified time slots so that advertising revenues could be maximized in accordance with the value delivered.

A further latent problem with modem advertising is to reflect the advertiser's needs with respect to receiving advertising billing which reflected specific desired dates, times of day, duration of display and specific locale.

There is therefore a need for a wireless system and apparatus for vehicles which aid vehicle safety and can substantially contemporaneously be utilized as an advertising medium and an anti theft/tamper mechanism, which would facilitate enabling and disabling (“locking” and “un-locking”) the vehicle's engine, ignition system and central locking system with a wireless device such as a cellular telephone, and which would incorporate “smart” features for determining such aspects of the function of the vehicle as the state of the vehicle, the history and location of the vehicle, and so forth, and also for enabling the user to monitor and/or alter the state of the vehicle and vehicle's locking from a relative distance.

There is a further need to facilitate rapid changes in vehicle display format and/or content to deliver the advertiser's message coordinated with the time of day and vehicle location and the parameters of the vehicle carrying the message, e.g. speed, outside weather conditions, density of like vehicles in same geographic zone, etc.

### SUMMARY OF THE INVENTION

The present invention is a wireless driver safety enhancement system and apparatus, which incorporates advertising capabilities and anti theft/tamper capabilities, either incorporated with a vehicle's mechanical door lock, vehicle's main electronic systems or alternatively, embodied as an electrical lock, which is controlled through a wireless device such as a cellular telephone for example or alternatively through a Global Positioning System (GPS) control system. The resulting safety system is preferably fitted with a set of one or more “smart” features, such as being able to determine, monitor and/or alter the state of the vehicle through the wireless device, for example. The system of the present invention preferably enables the smart feature(s) and the wireless device control to be incorporated into an existing vehicle to “retrofit” such a vehicle with the intelligent system of the present invention. Thus, the present invention enables computerized, digital, mechanical, electromechanical or electrical mechanisms within a vehicle to be controlled and operated by an intelligent system, through a remote wireless device.

According to the teachings of the present invention there is provided, an intelligent driver safety system, including a wireless receiver for receiving an instruction, a driver module for being activated by the wireless receiver upon receipt of the instruction; and a computational device for monitoring a state of the driver module. The intelligent lock further including an intelligent remote control device for controlling the system, the intelligent remote control device comprising a wireless transmitter for transmitting the instruction to the wireless receiver.

Hereinafter, the term “wireless device” refers to any device, which is capable of transmitting a signal to a receiver, which is not in direct physical proximity to the wireless device. A preferred example of a wireless device is a cellular telephone. Hereinafter, the term “cellular telephone” refers to any wireless device which is capable of transmitting and receiving at least voice data, and preferably other types of data, which is optionally connected to the PSTN (public switched telephone network).

### BRIEF DESCRIPTION OF THE DRAWINGS

The invention is herein described, by way of example only, with reference to the accompanying drawings, wherein:

FIG. 1 is a schematic diagram of the system and apparatus according to the present invention;

FIG. 2 shows a cross sectional image of the intelligent driver safety enhancement system installed on a vehicle according to the present invention; and

FIG. 3 shows a flow chart of an exemplary use of vehicle unit according to the present invention.

### DESCRIPTION OF THE PREFERRED EMBODIMENTS

The present invention relates to Vehicle safety systems and apparatus and, in particular, it concerns an “on-board” “anti collision” system and apparatus which can also be used to receive and display messages and a variety of different media.

Since the advent of the motor vehicle, a plethora of attempts have been made to improve safety for both passengers and pedestrians. Furthermore, due to the mobility of vehicles, several attempts have been made to utilize vehicles for advertising and the like.

The present invention is a wireless driver safety enhancement system and apparatus which incorporates advertising capabilities and anti theft capabilities, either incorporated with a vehicle's mechanical door lock or alternatively embodied as an electrical lock, which is controlled through a wireless device such as a cellular telephone, for example. The resulting safety system is preferably fitted with a set of one or more “smart” features, such as being able to determine, monitor and/or alter the state of the vehicle through the wireless device, for example. The system of the present invention preferably enables the smart feature(s) and the wireless device control to be incorporated into an existing vehicle to “retrofit” such a vehicle with the intelligent system of the present invention. Thus, the present invention enables mechanical, electromechanical or electrical mechanisms within a vehicle to be controlled and operated by an intelligent system, through a remote wireless device.

Hereinafter, the term “wireless device” refers to any device, which is capable of transmitting a signal to a receiver, which is not in direct physical proximity to the wireless device. A preferred example of a wireless device is a cellular telephone. Hereinafter, the term “cellular telephone” refers to any wireless device which is capable of transmitting and receiving at least voice data, and preferably other types of data, which is optionally connected to the PSTN (public switched telephone network).

It is understood that the terms “receiver” and “transmitter” are used for the sake of clarity, in order to indicate whether a particular component resides on the wireless remote control device (“transmitter”) or on the vehicle (“receiver”), as preferably both the remote control device and the lock feature a transceiver.

The principles and operation of the system and apparatus, according to the present invention, may be better understood with reference to the drawings and the accompanying description.

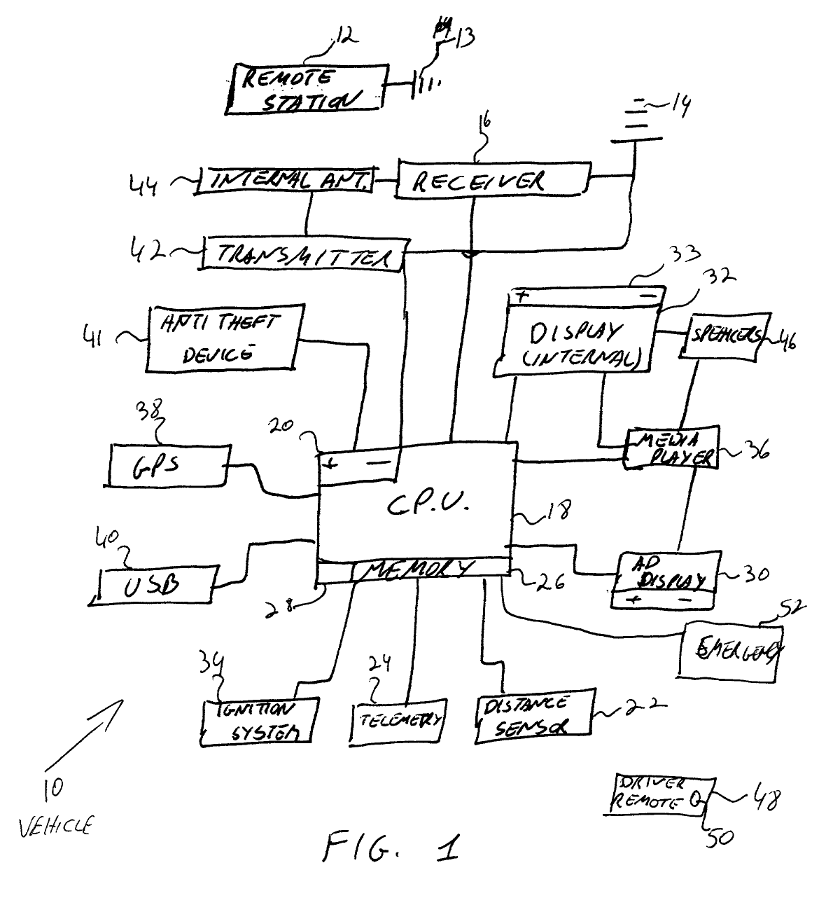

Referring now to the drawings, FIG. 1 shows a diagram of the intelligent driver safety enhancement system.

The system and apparatus shown in FIG. 1 are split into two main units, a vehicle unit 10 and a remote station 12. Vehicle unit 10 includes an antenna 14 electronically attached to, or integrally formed with a receiver 16. Preferably, receiver 16 is responsive to transmission transmitted from a transmitter 13 in remote station 12.

A Central Processing Unit (CPU) 18 is electronically attached to receiver 16 for decoding and processing signals received by receiver 16. Preferably CPU 18 includes a power supply 20 for powering vehicle unit 10 and CPU 18 further includes a memory module 26 for storing signals received.

Vehicle 10 preferably further includes a range finder distance sensor 22 for measuring the distance between vehicle unit 10 and other vehicles close proximity to vehicle unit 10. CPU 18 processes readings from sensor 22 as well as a plurality of vehicle telemetry readings 24. It is understood that the term “vehicle telemetry” includes readings from any of the vehicle systems including, but not limited to, Odometer, Tachometer, Speedometer, Engine thermometer, Oil Thermometer, Oil Pressure Gauge, Radiator and Vehicle battery.

Preferably, CPU 18 also includes a memory module 26 for storing readings of telemetry 24 and sensor 22. More preferably, memory module 26 includes a database 28 of dangerous and hazardous situations of telemetry 24, vehicle distance according to sensor 22 and the like. By way of example only, occasioning on a reading from sensor 22 conjunctively with vehicle speed, according to telemetry 24 matching a “dangerous situation” stored in database 28, a visual and/or audio warning to the driver behind vehicle unit 10 is displayed on an external display 30 situated at the rear of vehicle unit 10.

External display 30 is preferably capable of displaying a multiplicity of images and displays, including but not limited to, video, animation, “streaming”, photographs, scanned images, text messages, maps, JPEG's, MPEG's, MP3 files and “flash” technology graphics.

Preferably, a further visual warning is displayed to the driver by vehicle unit 10 on an internal display 32, such that the driver can take an appropriate action to quell the danger. More preferably, database 28 includes a list of appropriate actions to be taken in any given hazardous situation, which are displayed on external display 30 and internal display 32 to prevent any harm coming to vehicle unit 10, the occupants of the vehicle or any other vehicle or passengers in proximity to vehicle unit 10.

Preferably, internal display 32 is powered by a rechargeable display power supply 33. More preferably, display power supply 33 is solar powered for fuel economy. Additionally, vehicle unit 10 omits an audible or visual warning, such that the driver can take an appropriate action to quell the danger.

CPU 18 is also electronically connected to an ignition system 34 of vehicle 10, such that if a need rises, CPU 18 can shut off the engine of vehicle 10.

Preferably, vehicle unit 10 further includes a media player 36 capable of playing audio and video. Preferably, vehicle unit 10 can also be used as a video media advertisement. A commercial or single entity wishing to advertise a certain item can send a video or audio package from remote station 12 to vehicle unit 10 to be displayed on external display 30.

Preferably, streaming of an advertising to display 30 is further facilitated by the downstream of data originating from remote station 12 to vehicle unit 10.

Preferably, a user can send a video or audio package with instructions of display times and lengths. Thus, effective advertising is further enhanced.

Preferably, vehicle unit 10 further includes a Global Positioning System GPS 38 for positioning vehicle unit 10. Thus, information sent with a video package can also include geographical locations and zones in which to display the advertisement on external display 30.

Also preferably, vehicle unit 10 includes a BUS 40 for attaching a variety of external peripherals. By way of example only, Universal Serial Bus 40 is shown in FIG. 1, such that most modern computer peripherals can be attached to vehicle unit 10 to further enhance the systems capabilities, perform upgrades and the like.

Alternatively, vehicle unit 10 can be programmed to work autonomously of the engine of the vehicle. Thus, even when the vehicle is parked and the driver is absent, a plurality of media can be displayed on internal display 32 while utilizing energy stored by autonomous display power supply 33. Furthermore, even when the vehicle is parked and the driver is absent, a plurality of media can be displayed on external display 30 while utilizing energy stored by autonomous display power supply 33.

More preferably, vehicle unit 10 can be programmed to automatically shut off upon substantial depletion of display power supply 33 or a predetermined time or a command being received from remote station 12.

Preferably, vehicle unit 10 also includes an anti theft/tamper device 41 for preventing the theft of the vehicle. Occasioning on an unauthorized entry to the vehicle occurring, CPU 18 transmits the location of vehicle unit 10 with a transmitter 42 attached to both antenna 14 and a backup internal antenna 44. The location of stolen vehicle 10 is received at remote station 12 where a plurality of action can be taken which include, but are not limited to: sending instruction from remote station 12 to vehicle unit 10 to disconnect ignition system 34 of the vehicle, to display a “theft” warning on external display 30, to create a large siren or noise and sound it on a speaker 46 attached to media player 36 and to issue a warning message to the thief on internal display 32.

Preferably, a driver remote control 48 is provided for the user to control any and all displays appearing on internal display 32 and external display 30.

Preferably, a user can disable ignition system 34 with driver remote control 48. Thus, a further anti-theft element is augmented to vehicle unit 10. Preferably, driver remote control 48 features transponder capabilities, such that the driver can readily locate vehicle unit 10. Namely, the driver depresses a “location” switch 50 situated on driver remote control 48. Thereafter, a signal is sent from driver remote control 48 and received by receiver 16.

Upon receipt of the signal, CPU 18 processes the location of vehicle unit 10, according to data received from GPS 38. Thereafter, transmitter 42 transmits the location of vehicle 10 to driver remote control 48, thereby identifying the location of vehicle unit 10.

Preferably, substantially contemporaneously with a location request being received by vehicle unit 10, a visual signal is displayed on external display 30, for readily locating vehicle unit 10. Additionally, substantially contemporaneously with a location request being received by vehicle unit 10, an audible sound is omitted by speakers 46, for readily locating vehicle unit 10.

Alternatively, the driver calls or transmits to remote station 12 the request to receive the location of vehicle unit 10, such that remote station relays the position request to vehicle unit 10 and further relays the location sent from vehicle unit 10 to driver remote control 48.

Occasioning on a thief disconnecting or breaking antenna 14, internal backup antenna 44 is preferably invisible and thus all anti theft/tamper actions described above are not foiled by the perpetrator's vandalism.

Preferably, an emergency button 52 is included in vehicle unit 10, such that a user in physical danger, distress or any risk, can manually activate emergency button 52. Thereafter, audio and visual alerts are displayed on external display 30 and sounded on speakers 46.

Preferably, when a user depresses emergency button 52 on vehicle unit 10, vehicle unit 10 sends an emergency request signal to remote station 12, Thereafter, operators of remote station 12 can summon the appropriate assistance or contact the user for further and better particulars of the emergency.

Especially preferred, any user can utilize any vehicle unit 10 from any cellular phone. Thus, a user can decide to display any type of advertisement for any duration of time, on any quantity of vehicles, in any zone or geographical location. Preferably, the user will be billed according to the duration of time, the quantity of vehicles and any zone or geographical location the advertisements appear. Additionally, any competent authority, including, but not limited to, the police and fire brigade can utilize the system to advise drivers of a wide variety of hazards according to any zone or geographical location of the vehicle, either by direct display on external display 30 and internal display 32, or by overriding an advertisement being displayed on external display 30.

Occasioning on CPU 18 detecting a hazardous or dangerous situation substantially contemporaneously as an advertisement being displayed on external display 30, CPU 18 performs a system override and a visual warning to the driver behind vehicle unit 10 is displayed on external display 30 situated at the rear of the vehicle.

Preferably, a further visual and/or audio warning is displayed to the driver by vehicle unit 10 on an internal display 32, such that the driver can take an appropriate action to quell the danger. Preferably, an appropriate action to be taken in any given hazardous situation is displayed on external display 30 and internal display 32, to prevent any harm coming to vehicle unit 10, the occupants of the vehicle or any other vehicle or passengers in proximity to vehicle unit 10.

Additionally and preferably, vehicle unit 10 omits an audible or visual warning, such that the driver can take an appropriate action to quell the danger.

Once the dangerous or hazardous situation has passed, the advertisement is displayed again on external display 30, from the point it was stopped or from the beginning, according to user preference or a predetermined database 28.

It is understood that the mechanism described hereinabove can be electronically connected to the electronic systems of the vehicle. Furthermore, it is further understood that vehicles including an alarm system, the alarm system would preferably be electronically connected to vehicle unit 10.

Thus, according to the present invention shown in FIG. 1, a mobile visual display system 10 includes one or more vehicles, e.g. taxis, passenger vehicles, buses, tractor-trailers, etc., equipped with an external display panel 30 and an internal display panel 32, capable of delivering changeable messages e.g., LED, liquid crystal, etc., and a programmable on-board controller CPU 18, which drives the display panels to provide a viewable message. The controller CPU 18 ascertains that the vehicle is within a predefined geographic zone, which can be customized for each message and drives external display 30 to generate a message selected for public viewing. The message is displayed on external display 30, pursuant to a schedule stored on database 28, which includes date, time of day and display duration while the vehicle is within the zone or until the vehicle is located in another zone which is not within the message schedule.

Controller CPU 18 maintains a transaction record on database 28 of times, dates, zone locations, monitored vehicle parameters and duration of each message displayed. Each controller CPU 18 is in communication with fixed remote stations 12 from which remote stations 13, CPU 18 receives and transmits programming data, message content and scheduling data. Stations 12 process the transaction records to generate advertiser billing and other accounting records. Stations 12 also perform analysis of the transaction records and billing records and generate advertiser fee schedules as well as revised zone definitions.

The mobile system of the present invention shown in FIG. 1 is for conveying messages. The system includes a vehicle unit 10 adapted to traverse a geographic region, the region being segregated into zones. External display 30 carried by the vehicle is connected to controller CPU 18 such that controller CPU 18 drives external display 30 to generate publicly viewable messages selected for a first zone within which the vehicle is located.

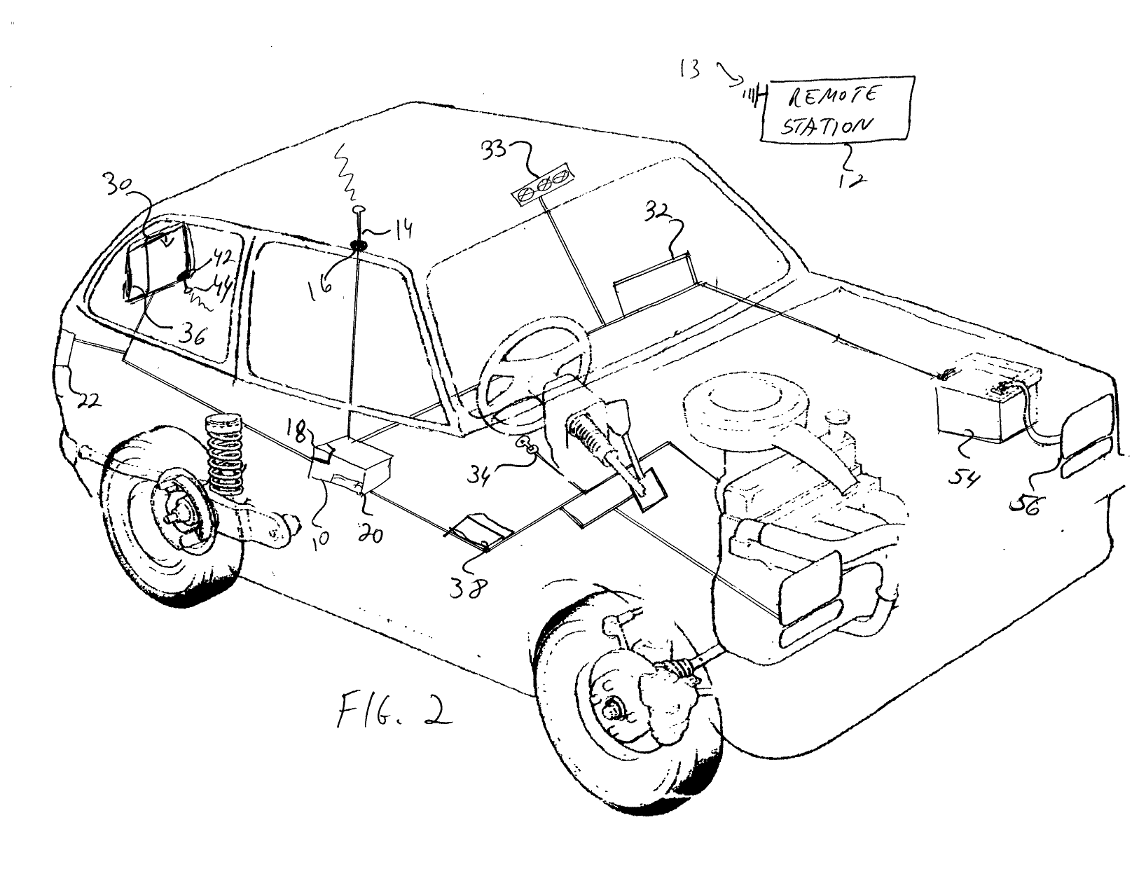

FIG. 2 shows a cross sectional image of the intelligent driver safety enhancement system installed on a vehicle.

The system and apparatus shown in FIG. 2 shows a vehicle unit 10 including an antenna 14 electronically attached to, or integrally formed with a receiver 16. Preferably, receiver 16 is responsive to transmission transmitted from a transmitter 13 in a remote station 12.

A Central Processing Unit (CPU) 18 is electronically attached to receiver 16 for decoding and processing signals received by receiver 16. Preferably, CPU 18 includes a power supply 20 for powering vehicle unit 10.

Vehicle 10 preferably further includes a range finder distance sensor 22 for measuring the distance between vehicle unit 10 and other vehicles close proximity to vehicle unit 10. CPU 18 processes Readings from sensor 22 substantially conjunctively with a plurality of vehicle telemetry readings 24 (not shown in FIG. 2). It is understood the term “vehicle telemetry” includes readings from any of the vehicle systems including, but not limited to, Odometer, Tachometer, Speedometer, Engine thermometer, Oil Thermometer, Oil Pressure Gauge, Radiator and Vehicle battery.

By way of example only and as described hereinabove, occasioning on a reading from sensor 22 conjunctively with vehicle speed, according to telemetry 24 matching a “dangerous situation” described hereinabove, a visual and/or audio warning to the driver behind vehicle unit 10 is displayed on an external display 30 situated at the rear of vehicle unit 10.

Similarly, a further visual warning is displayed to the driver by vehicle unit 10 on an internal display 32, such that the driver can take an appropriate action to quell the danger. Like above, a list of appropriate actions to be taken in any given hazardous situation, which are displayed on external display 30 and internal display 32 to prevent any harm coming to vehicle unit 10, the occupants of the vehicle or any other vehicle or passengers in proximity to vehicle unit 10.

Preferably, internal display 32 is powered by a rechargeable solar power supply 33. CPU 18 is also electronically connected to an ignition system 34 of vehicle 10, such that if a need rises, CPU 18 can shut off the engine of vehicle 10.

Preferably, vehicle unit 10 further includes a media player 36 capable of playing audio and video. Preferably, vehicle unit 10 can also be used as a video media advertisement. A commercial or single entity wishing to advertise a certain item can send a video or audio package from remote station 12 to vehicle unit 10 to be displayed on external display 30.

Preferably streaming of an advertising to display 30 is further facilitated by the downstream of data originating from remote station 12 to vehicle unit 10.

Preferably, a user can send a video or audio package with instructions of display times and lengths. Thus, effective advertising is further enhanced.

Preferably, vehicle unit 10 further includes a Global Positioning System (GPS) 38 for positioning vehicle unit 10. Thus, information sent with a video package can also include geographical locations and zones in which to display the advertisement on external display 30.

Like above, vehicle unit 10 can be programmed to work autonomously of the engine of the vehicle. Thus, even when the vehicle is parked and the driver is absent, a plurality of media can be displayed on internal display 32 while utilizing energy stored by solar power supply 33. Furthermore, even when the vehicle is parked and the driver is absent, a plurality of media can be displayed on external display 30, while utilizing energy stored by solar power supply 33.

More preferably, vehicle unit 10 can be programmed to automatically shut off upon substantial depletion of display power supply 33 or a predetermined time or a command being received from remote station 12.

Alternatively, upon depletion of solar power supply 33, a user can select to utilize energy from a vehicle battery 54 found in modern vehicles.

Preferably, vehicle unit 10 also includes an anti theft/tamper device 41 for preventing the theft of the vehicle. Occasioning on an unauthorized entry to the vehicle occurring, CPU 18 transmits the location of vehicle unit 10 with a transmitter 42 attached to both antenna 14 and a backup internal antenna 44. The location of stolen vehicle 10 is received at remote station 12 where a plurality of action can be taken which include, but are not limited to: sending instruction from remote station 12 to vehicle unit 10 to disconnect ignition system 34 of the vehicle, to display a “theft” warning on external display 30, to turn on and off at least one vehicle light 56 and to issue a warning message to the thief on internal display 32.

Similarly, a driver can call or transmit to remote station 12 the request to receive the location of vehicle unit 10, such that remote station relays the position request to vehicle unit 10.

Occasioning on a thief disconnecting or breaking antenna 14, internal backup antenna 44 is preferably invisible and thus all anti theft/tamper actions described above are not foiled by the perpetrator's vandalism.

Especially preferred, any user can utilize any vehicle unit 10 from any cellular phone. Thus, a user can decide to display any type of advertisement for any duration of time, on any quantity of vehicles, in any zone or geographical location. Preferably, the user will be billed according to the duration of time, the quantity of vehicles and any zone or geographical location the advertisements appear. Additionally, any competent authority, including, but not limited to, the police and fire brigade can utilize the system to advise drivers of a wide variety of hazards according to any zone or geographical location of the vehicle, either by direct display on external display 30 and internal display 32, or by overriding an advertisement being displayed on external display 30.

Like above, occasioning on CPU 18 detecting a hazardous or dangerous situation substantially contemporaneously as an advertisement being displayed on external display 30, CPU 18 performs a system override and a visual warning to the driver behind vehicle unit 10 is displayed on external display 30 situated at the rear of the vehicle.

Preferably, a further visual and/or audio warning is displayed to the driver by vehicle unit 10 on an internal display 32, such that the driver can take an appropriate action to quell the danger. Preferably, an appropriate action to be taken in any given hazardous situation is displayed on external display 30 and internal display 32, to prevent any harm coming to vehicle unit 10, the occupants of the vehicle or any other vehicle or passengers in proximity to vehicle unit 10.

Additionally and preferably, vehicle unit 10 omits an audible or visual warning, such that the driver can take an appropriate action to quell the danger.

Once the dangerous or hazardous situation has passed, the advertisement is displayed again on external display 30, from the point it was stopped or from the beginning, according to user preference or a predetermined database 28.

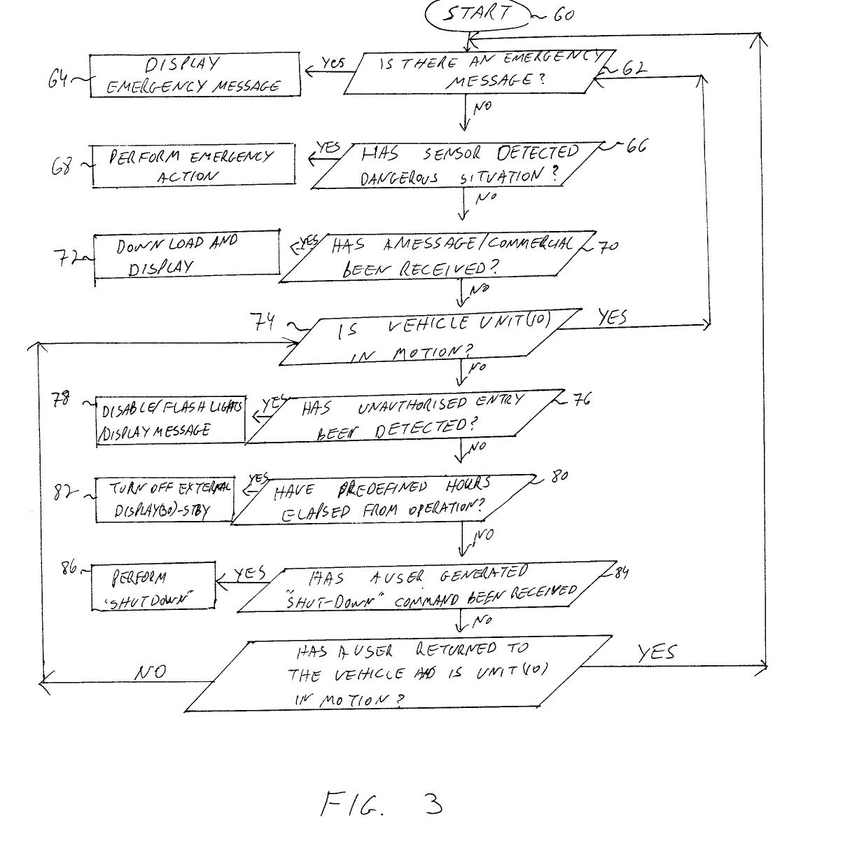

FIG. 3 shows a flow chart of an exemplary use of a vehicle unit 10. A user starts vehicle unit 10 at a step 60. At a step 62, occasioning on a reading from sensor 22 shown in FIG. 1, conjunctively with vehicle speed, according to telemetry 24 shown in FIG. 1, matching a “dangerous situation” stored in database 28 of FIG. 1, a step 64 initiates a visual and/or audio warning to the driver behind vehicle unit 10 is displayed on an external display 30 of FIG. 1.

Returning to step 62, occasioning on a dangerous situation not being reached, a step 66 checks readings from sensor 22 of FIG. 1 substantially conjunctively with telemetry 24 of FIG. 1. Occasioning on a reading from sensor 22 conjunctively with vehicle speed, according to telemetry 24 matching a “dangerous situation” stored in database 28 of FIG. 1, a step 68 initiates a visual and/or audio warning to the driver behind vehicle unit 10 is displayed on an external display 30 of FIG. 1.

Returning to step 66, Occasioning on no “dangerous situation” being detected, a step 70 checks whether a commercial or visual display have been received from remote station 12 of FIG. 1. Occasioning on a commercial or displayable image or text being received from remote station 12, the image and commercial are downloaded to database 28 of FIG. 1 at a step 72 shown in FIG. 3. Thereafter, the commercial and/or images are displayed on external display 30 of FIG. 1.

Returning to step 70, if no message or instruction is received from remote station 12 of FIG. 1, a step 74 checks whether vehicle unit 10 is in motion or stationary. If vehicle unit 10 is in motion the process from step 62 is repeated as described hereinabove. At a step 76, if vehicle unit 10 is stationary and an unauthorized entry to the vehicle occurs, as described in FIG. 1, CPU 18 transmits the location of vehicle unit 10 with a transmitter 42 attached to both antenna 14 and a backup internal antenna 44. Furthermore, at step 78 the location of stolen vehicle 10 is received at remote station 12 where a plurality of action can be taken which include, but are not limited to: sending instruction from remote station 12 to vehicle unit 10 to disconnect ignition system 34 of the vehicle, to display a “theft” warning on external display, to create a large siren or noise and sound it on a speaker 46 attached to media player 36 and to issue a warning message to the thief on internal display 32 of FIG. 1.

Returning to step 76, if an unauthorized entry to the vehicle does not occur, at a step 80 the time the vehicle has not been in motion is measured. If the time exceeds a predetermined time frame, at a step 82, external display 30 of FIG. 1 enters a “sleep” mode for energy conservation.

Occasioning on a “shut down” instruction being received from remote station 12 being received at a step 84, vehicle unit 10 shuts down at a step 86, until vehicle unit 10 is initialized and returns to step 60 described hereinabove.

Returning to step 84, if a “shut down” instruction is not received, and vehicle unit 10 remains stationary a step 86 returns vehicle unit 10 to step 74. At step 86, if the user returns to the vehicle and vehicle unit 10 is no longer stationary, step 86 returns vehicle unit 10 to step 62.

It will be appreciated that the above descriptions are intended only to serve as examples, and that many other embodiments are possible within the spirit and the scope of the present invention.

What is claimed is:

1. An intelligent vehicle safety system, comprising:
(a) an intelligent on-board mechanism, said mechanism comprising:
(i) a wireless receiver for receiving an instruction;
(ii) a driver module for being activated by said wireless receiver upon receipt of said instruction;
(iii) a computational device for monitoring a state of said driver module; and
(iv) a display for displaying messages received by said wireless receiver; and
(b) an intelligent remote control device for controlling said intelligent mechanism, said intelligent remote control device comprising a wireless transmitter for transmitting said instruction to said wireless receiver.

2. The system of claim 1, further comprising a range finder distance sensor for measuring the distance between said on-board mechanism and other vehicles in close proximity to said on-board mechanism.

3. The system of claim 1, wherein said intelligent on-board mechanism controls the engine of the vehicle.

4. The system of claim 1, wherein said display is solar powered.

5. The system of claim 1, wherein said system works autonomously to the engine of the vehicle.

6. The system of claim 1, wherein said system is programmed to shut off after a predetermined time.

7. A method for enhancing vehicle safety with advertising capabilities comprising:
a. Providing a system and apparatus including:
b. Performing the steps:
i. storing an electronic message within a memory of a computer, the electronic message including information for identifying an intended recipient of the electronic message, the computer being bidirectionally coupled to a data communications network;
ii. transferring information to the computer, the transferred information including a portion that contains an identification of an occupant of the vehicle;
iii. in response to the portion of the transferred information matching the information of a stored one of the electronic messages that identifies the intended recipient of the electronic message, retrieving the stored one of the electronic messages and transmitting the retrieved electronic message from the computer to said display;
iv. receiving the electronic message and displaying electronic message on said display; and
v. presenting the received electronic message to the occupant of the vehicle.
